(19) United States
(12) Patent Application Publication
(10) Pub. No.: US 2006/0078129 A1
(43) Pub. Date: Apr. 13, 2006

(54) Sound system with a speaker box having multiple speaker units

(75) Inventor: Niro Nakamichi, Tokyo (JP)

Correspondence Address: DARBY & DARBY P.C., P. O. BOX 5257, NEW YORK, NY, 10150-5257, US

(73) Assignee: niro1.com Inc., Tokyo (JP)

(21) Appl. No.: 11/241,725

(22) Filed: Sep. 29, 2005

Related U.S. Application Data
(60) Provisional application No. 60/614,239, filed on Sep. 29, 2004.

(51) Int. Cl. H04R 5/00; H04R 5/02

(52) U.S. Cl. 381/18; 381/19; 381/310

(57) ABSTRACT

Presented is a surround sound system including a loudspeaker enclosure containing a left speaker, a right speaker, and a center speaker. The speakers receive separate audio signals previously processed by a channel decoder. A virtualizer performs a head related transfer function (HRTF) on at least two audio channels. First and second summers respectively combine a front L signal with a post-HRTF L signal, and a front R signal with post-HRTF R signal. The respective combined front L and front R signals are then provided through respective amplifiers to the front L speaker and the front R speaker so as to produce front and rear signals. In another aspect, a loudspeaker enclosure contains first and second left speakers, first and second right speakers, and a center speaker. Wherein the second left speaker and the second right speaker receive respective left surround and right surround post-HRTF virtualizer audio signals.

### CLAIM OF PRIORITY

This application claims the benefit of priority, under 35 U.S.C. § 119(e), of U.S. Provisional Application No. 60/614,239, filed Sep. 29, 2004, and titled “Sound System With A Speaker Box having Multiple Speaker Units,” which is hereby incorporated by reference in its entirety.

### FIELD OF INVENTION

This invention relates generally to a sound system and method for reproducing audio signals, and more particularly to a sound system that includes at least one speaker box that contains multiple speaker units so as to produce a virtual surround sound environment.

### BACKGROUND OF THE INVENTION

Playback of multi-channel signals, such as Dolby digital signals, generally requires a speaker for each channel In the case of a Dolby digital system, for example, a total of six channels are played back: an L channel, an R channel, a center channel for the front, a surround L channel and a surround R channel for the rear, and a subwoofer channel for low frequencies. Thus, six speakers must be used.

A speaker cable must be laid from the amplifier to each of these speakers. For hi-fi playback, these speaker cables must be as short as possible. Laying of six cables laid across the floor can damage the appearance of the room and can prevent the speakers from being placed in appropriate places.

What is missing from the art is a single speaker enclosure capable of producing a surround sound environment for a user to experience. The present invention satisfies this and other needs.

### SUMMARY OF THE INVENTION

In accordance with one aspect of the invention, a surround sound system includes a loudspeaker enclosure containing a front L speaker, a front R speaker, and a center speaker. The speakers receive separate audio track signals produced by an audio source. The separate audio tracks are processed by a channel decoder under the control of a microprocessor interconnected with at least the audio source and the channel decoder. A virtualizer connected to at least two audio channels from the decoder performs a head related transfer function (HRTF) on the connected audio channels, which are then converted to an analog signal by a digital-to analog-converter (DAC) coupled to the channel decoder and the virtualizer. A plurality of corresponding amplifiers connected to respective corresponding DAC analog output signals amplify the audio signals and provide them to the respective front L speaker, the front R speaker, the center speaker, and a sub speaker.

In another aspect of the invention, first and second summers respectively combine a front L signal with a post-HRTF L signal, and a front R signal with post-HRTF R signal. The respective combined front L and front R signals are then provided through respective amplifiers to the front L speaker and the front R speaker so as to produce front and rear signals.

In yet another aspect of the invention, a loudspeaker enclosure contains first and second front L speakers, first and second front R speakers, and a center speaker. Wherein the second front L speaker and the second front R speaker receive respective left surround and right surround post-HRTF virtualizer audio signals.

The above, and other objects, features and advantages of the present invention will become apparent from the following description read in conjunction with the accompanying drawings, in which like reference numerals designate the same elements.

### BRIEF DESCRIPTION OF THE DRAWINGS

FIGS. 1-3 illustrate a speaker box in accordance with an embodiment of the present invention;

FIG. 4 depicts a schematic of a sound system in accordance with an embodiment of the present invention;

FIGS. 5-7 illustrate a speaker box in accordance with another embodiment of the present invention; and

FIG. 8 depicts a schematic of a sound system in accordance with another embodiment of the present invention.

### DESCRIPTION OF AN ILLUSTRATIVE EMBODIMENT

By way of overview and introduction, a sound system that includes a speaker box having multiple speaker units is described. The sound system reproduces recorded audio signals that include at least three independent channels, a front right, front left and a front center channel. These three independent channels exist as separate tracks on the recorded audio source.

In one embodiment, the sound system also reproduces a rear right channel and a rear left channel signals that also exist as separate tracks on the recorded audio source. The sound system includes a processor, memory and program instructions operable to perform a digital signal processing algorithm on the rear right and left signals. The virtualizer 16 can optionally contain the processor, memory and program instructions.

The digital signal processing algorithm optionally implements a Head Related Transfer Function (HRTF) on the rear right and rear left signals. The HRTF captures all of the physical cues to source localization. Once the HRTF for the left ear and the right ear are known, accurate binaural signals can be synthesized. The HRTF is based on sound level differences and time of arrival differences of input signals at a user's ears. The spectral cues caused by these differences is related to localization of the sound. The HRTF is a complicated function of four variables: three space coordinates and frequency. In spherical coordinates, for distances greater than about one meter, the source is said to be in the far field, and the HRTF falls off inversely with range. Most HRTF measurements are made in the far field, which essentially reduces the HRTF to a function of azimuth, elevation and frequency.

The HRTF processing allows for the rear signals to be produced by the front speaker units, while a user perceives that the signals are being produced by a sound source from the rear. The HRTF transformed rear signals is provided to and produced by the front right and front left speaker units at the same time as the front right channel and front left channel signals.

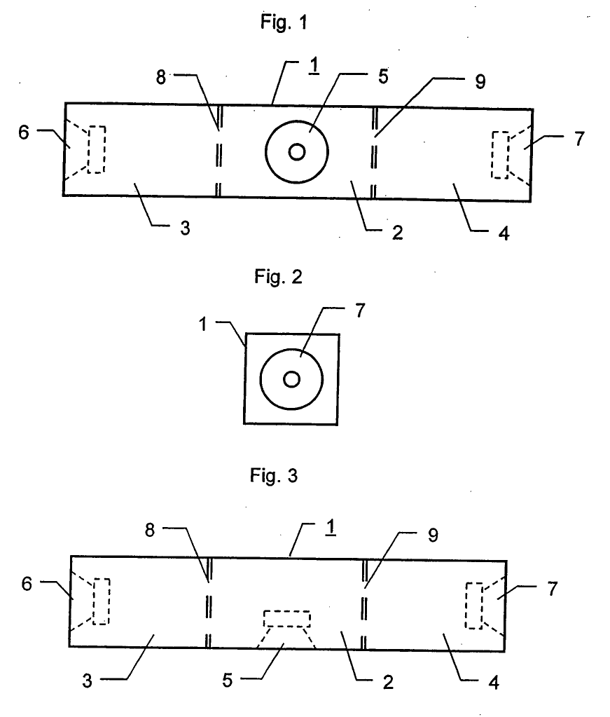

FIGS. 1-3 illustrate speaker box 1 which includes a front right speaker unit 7, a front left speaker unit 6, and a front center speaker unit 5. The relative positions within the speaker box 1 of at least the front right 7 and front left 6 speaker units is maintained to assure proper perception of the HRTF transformed rear signals.

A center channel speaker 5 is provided for multi-channel audio reproduction. Prior art surround systems have two speakers which are used to produce a virtual surround sound system. In such prior art surround systems the center channel is produced by combining the sound waves produced by the two speaker outputs. In contrast, the present embodiment provides a center speaker 5 along with a center channel signal and a center channel speaker driver to produce an actual center channel. The present invention provides the surround sound experience from a single speaker box 1.

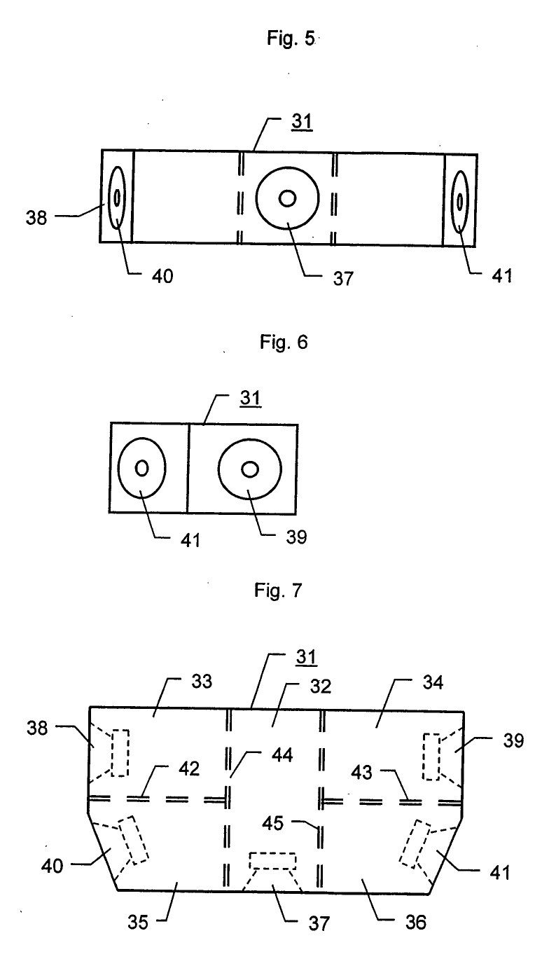

FIGS. 5-7 illustrate another embodiment for a speaker box 31 in accordance with the invention. The speaker box 31 includes two left speaker units 38, 40, two right speaker units 39, 41 and a front center channel speaker unit 37. One set of left and right speakers (e.g., 38, 39) produces the corresponding left and right front channel signals, and the other set of left and right speakers (e.g., 40, 41) produces the corresponding post-HRTF transform right and left rear channel signals. This configuration reduces interference between the front and rear signal channels derived from producing the front and rear signal channels from the same speaker unit. Precise positioning of the relative distance between the right and left speaker units maintains the spatial quality of the perceived signal.

In particular, the five speaker units 37, 38, 39, 40 and 41 are provided with one speaker box 31. The one speaker box approach to provide the full surround sound experience has an advantage in setting up speaker in the room. Providing the front L and front R speakers in one box could be disadvantageous; if the distance between front L and front R channel speakers is too close, the stereo image reproduction could be narrow. To overcome this problem, in this embodiment the front L channel speaker 38 is mounted on the opposite side of the front R channel speaker 39 (at about 180 degree position), thus, reproducing the sound in opposite directions. In this case, the preferable location to mount the rear L and rear R surround speakers (e.g., 40, 41) is intermediate between center channel speaker 37 and respective front L and front R speakers 38, 39.

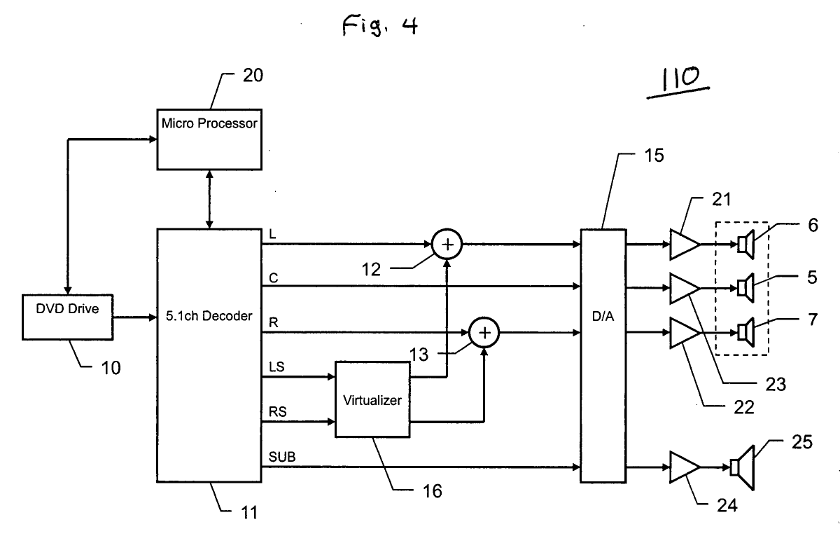

FIG. 4 is a schematic of one embodiment for a sound system 110 in accordance with the present invention. The sound system 110 includes an audio source 10, which can be a DVD, a CD, or any other audio source capable of providing individual, separate audio tracks. The microprocessor 20 controls sound system 110 and is also capable of serving as the virtualizer 16. Although, in this embodiment the virtualizer 16 is depicted as a separate device. A channel decoder 11 process the individual tracks provided by the audio source 10, and develops a left L, a right R, and center C front channels. The decoder also develops rear L and rear R signals in the form of left LS surround signal and right RS surround signal, as well as a SUB woofer signal. The L, R, and C front channel signals are independent of each other and are the result of separate, individual tracks provided by the audio source 10. As is known by a person of ordinary skill, these separate and individual tracks can be multiplexed together to reduce storage space and bandwidth overhead, but are de-multiplexed into separate audio signals.

The virtualizer 16 processes the LS and RS signals synthesize the binaural signals for the HRTF signals. Summer units 12 and 13 combine the virtualizer output post-HRTF transform rear signals with corresponding R and L front channel signals. A digital-to-analog converter (D/A) 15 converts the digital channel signals to an audio signal for amplification by amplifiers 21-24.

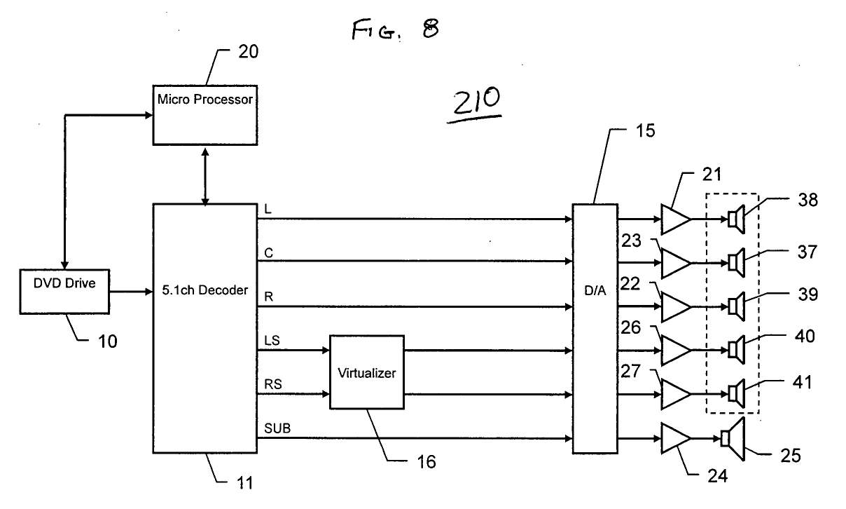

FIG. 8 is a schematic of sound system 210, in accordance with another embodiment of the present invention. Like numbers represent like features from FIG. 4. In this embodiment, left and right speakers 40, 41 produce the post-HRTF transform right and left rear channel signals. Sound system 210 supplies the virtualizer 16 output post-HRTF transform rear channel signals to the D/A 15, where they are converted to analog signals and provided to respective amplifiers 26, 27 prior to being sent to left and right speaker units 40, 41 for production.

Thus, while there have been shown, described, and pointed out fundamental novel features of the invention as applied to illustrated embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements steps which perform substantially the same, function in substantially the same way, to achieve the same results are within the scope of the invention. Substitutions of elements from one embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

I claim:

1. A sound system for producing surround sound comprising:
a loudspeaker enclosure containing a front L speaker, a front R speaker, and a center speaker;
an audio source operable to produce separate audio track outputs;
a channel decoder connected to the audio track outputs and configured to provide output audio channels;
a microprocessor interconnected with at least the audio source and the channel decoder, wherein the microprocessor is operable to control the sound system;
a virtualizer connected to at least two output audio channels, wherein the virtualizer is operable to perform a head related transfer function (HRTF) on the connected output audio channels;
a digital to analog converter (DAC) coupled to the channel decoder and the virtualizer, wherein the DAC is operable to provide corresponding analog output signals;
a plurality of corresponding amplifiers connected to respective corresponding DAC analog output signals, wherein the plurality of amplifiers are operable to provide amplified audio signals to the respective front L speaker, the front R speaker, the center speaker, and a sub speaker.

2. The sound system of claim 1, wherein the microprocessor is configured to be the virtualizer.

3. The sound system of claim 1, further comprising:
a first summer, which is operable to combine a left signal output of the channel decoder with a left HRTF output of the virtualizer; and
a second summer, which is operable to operable to combine a right signal output of the channel decoder with a right HRTF output of the virtualizer;

4. The sound system of claim 3, wherein the DAC is connected to the first summer, the second summer, a sub channel output of the channel decoder, and a center channel output of the channel decoder.

5. The sound system of claim 4, wherein the output of the first summer and the output of the second summer are provided, respectively, to the front L speaker and the front R speaker, wherein the front L speaker and the front R speaker produce respective front and rear channel sound.

6. The sound system of claim 1, wherein the front L speaker and the front R speaker are disposed within the speaker enclosure at a position of 180° relative to each other.

7. The sound system of claim 1, wherein the center speaker is disposed within the speaker system at a position of 90° relative to both the front L speaker and the front R speaker.

8. A sound system for producing surround sound comprising:
a loudspeaker enclosure containing first and second front L speakers, first and second front R speakers, and a center speaker;
an audio source operable to produce separate audio track outputs;
a channel decoder connected to the audio track outputs and configured to provide output audio channels;
a microprocessor interconnected with at least the audio source and the channel decoder, wherein the microprocessor is operable to control the sound system;
a virtualizer connected to at least two output audio channels, wherein the virtualizer is operable to perform a head related transfer function (HRTF) on the connected output audio channels;
a digital to analog converter (DAC) coupled to the channel decoder and the virtualizer, wherein the DAC is operable to provide corresponding analog output signals;
a plurality of corresponding amplifiers connected to respective corresponding DAC analog output signals, wherein the plurality of amplifiers are operable to provide amplified audio signals to the respective first and second front L speakers, the first and second front R speakers, the center speaker, and a sub speaker.

9. The sound system of claim 8, wherein the microprocessor is configured to be the virtualizer.

10. The sound system of claim 8, wherein the first front L speaker and the first front R speaker are disposed within the speaker enclosure at a position of 180° relative to each other.

11. The sound system of claim 8, wherein the center speaker is disposed within the speaker system at a position of 90° relative to both the first front L speaker and the first front R speaker.

12. The sound system of claim 8, wherein the second front L speaker and the second front R speaker receive respective left surround and right surround audio signals, wherein the left surround and right surround audio signals are provided by the virtualizer post-performance of the HRTF.

13. The sound system of claim 8, wherein the second front L speaker and the second front R speaker are disposed within the speaker enclosure at positions between the center speaker and the respective first front L speaker and the first front R speaker.
